(19) United States
(12) Patent Application Publication
(10) Pub. No.: US 2021/0064665 A1
(43) Pub. Date: Mar. 4, 2021

(54) SYSTEMS AND METHODS FOR ONLINE TO OFFLINE SERVICES

(71) Applicant: BEIJING DIDI INFINITY TECHNOLOGY AND DEVELOPMENT CO., LTD., Beijing (CN)

(72) Inventors: Ji ZHAO, Beijing (CN); Huan CHEN, Beijing (CN); Qi SONG, Beijing (CN); Li MA, Beijing (CN)

(73) Assignee: BEIJING DIDI INFINITY TECHNOLOGY AND DEVELOPMENT CO., LTD., Beijing (CN)

(21) Appl. No.: 17/094,769

(22) Filed: Nov. 10, 2020

Related U.S. Application Data
(63) Continuation of application No. PCT/CN2019/073181, filed on Jan. 25, 2019.

(30) Foreign Application Priority Data
Jan. 19, 2019 (CN) 201910062679.X

(51) Int. Cl. G06F 16/9032; G06F 16/9535; G06F 16/2457; G06N 20/00

(52) U.S. Cl. CPC G06F 16/90328; G06N 20/00; G06F 16/24578; G06F 16/9535

(57) ABSTRACT

The present disclosure relates to systems and methods for determining at least one recommended search strategy for a user query. The method may include receiving the user query including at least one first segment from a terminal device; obtaining a plurality of search strategies matching the user query, each search strategy including at least one second segment; obtaining a text similarity determination model adapted to incorporate an attention mechanism; for each of the plurality of search strategies, determining a similarity score between a first vector representing the user query and a second vector representing the search strategy based on the text similarity determination model, at least one of the first vector or the second vector being associated with an attention weight of each corresponding segment; and determining the at least one recommended search strategy based on the similarity scores among the plurality of search strategies.

### CROSS-REFERENCE TO RELATED APPLICATIONS

This application is a continuation of International Application No. PCT/CN2019/073181, field on Jan. 25, 2019, which claims priority of Chinese Patent Application No. 201910062679.X filed on Jan. 19, 2019, the entire content of which is incorporated herein by reference.

### TECHNICAL FIELD

The present disclosure generally relates to Online to Offline (O2O) service platforms, and in particular, to systems and methods for determining recommended search strategies in response to a user query received from a terminal device.

### BACKGROUND

With the development of Internet technology, O2O services, such as online car hailing services and delivery services, play a more and more significant role in people's daily lives. When a user makes a request for an O2O service to an O2O platform via a user terminal, he/she may need to manually input a query, for example, a name or an address of a destination. After receiving the query, the O2O platform may determine one or more recommended search strategies, for example, one or more points of interest (POIs) matching the query based on one or more predetermined rules (e.g., according to text similarities between the query and the recommended POI(s)), and transmit the recommended POIs to the user terminal by a list. However, in some occasions, it can be inefficient to determine the recommended POIs based on the predetermined rules, which often have poor performance on error correlation or words correlation (e.g., synonyms) determination. Thus, it is desirable to provide effective systems and methods for determining recommended search strategies in response to a user query received from a user terminal efficiently to improve the user experience.

### SUMMARY

According to one aspect of the present disclosure, a system for determining at least one recommended search strategy in response to a user query received from a terminal device is provided. The system may include a data exchange port adapted to communicate with the terminal device, at least one non-transitory computer-readable storage medium having stored thereon a set of computer-executable instructions, and at least one processor adapted to communicate with the data exchange port and the at least one non-transitory computer-readable storage medium. When executing the set of instructions, the at least one processor may be configured to perform the following operations. The at least one processor may receive the user query from the terminal device via the data exchange port. The user query may include at least one first segment. The at least one processor may also obtain a plurality of search strategies matching the user query in response to the user query. Each of the plurality of search strategies may include at least one second segment. The at least one processor may also obtain a text similarity determination model. The text similarity determination model may be adapted to incorporate an attention mechanism. For each of the plurality of search strategies, the at least one processor may determine a similarity score between a first vector representing the user query and a second vector representing the search strategy. The similarity score may be determined by inputting the user query and the search strategy into the text similarity determination model. At least one of the first vector or the second vector may be associated with an attention weight of each corresponding segment in the corresponding vector. The attention weight may be determined based on the attention mechanism. The at least one processor may also determine the at least one recommended search strategy based on the similarity scores among the plurality of search strategies. The at least one processor may also transmit the at least one recommended search strategy to the terminal device for display.

In some embodiments, the text similarity determination model may include a first module configured to generate the first vector based on the user query, a second module configured to generate the second vector based on the search strategy, and a similarity determination layer configured to determine the similarity score between the first vector and the second vector.

In some embodiments, the first module may include a contextual representation component configured to determine a first feature vector of the user query and an attention extraction component configured to generate the first vector based on the first feature vector of the user query. The first vector may be associated with a first attention weight of each first segment in the first vector.

In some embodiments, the contextual representation component may include a segmentation layer configured to segment the user query into the at least one first segment, an embedding layer configured to generate a word embedding of the user query, and a convolution layer configured to extract the first feature vector of the user query from the word embedding of the user query.

In some embodiments, the attention extraction component of the first model may include a normalization layer configured to normalize the first feature vector of the user query and a self-attention layer. The self-attention layer may be configured to determine the first attention weight of each first segment in the normalized first feature vector and generate a modified first feature vector based on the normalized first feature vector and the first attention weight of each first segment.

In some embodiments, the attention extraction component of the first model further may include a fully-connected layer configured to process the modified first feature vector the modified first feature vector to generate the first vector, the first vector having the same number of dimensions as the second vector.

In some embodiments, the user query may be related to a location, and the plurality of search strategies may include a plurality of point of interest (POI) strings. Each of the POI string may include the at least one second segment.

In some embodiments, each of the plurality of POI strings may include a POI name and a corresponding POI address. The at least one second segment of each of the plurality of POI strings may include at least one name segment of the corresponding POI name and at least one address segment of the corresponding POI address. The second model may include a POI name unit configured to determine a POI name vector representing the POI name, a POI address unit configured to determine a POI address vector representing the POI address, and an interactive attention component configured to generate a third vector representing the POI string based on the POI name vector and the POI address vector. The third vector may be associated with a second attention weight of each name segment and each address segment in the third vector.

In some embodiments, the POI name model may include a first contextual representation component configured to determine a POI name feature vector of the POI name and a first attention extraction component configured to generate the POI name vector based on the POI name feature vector. The POI name vector may be associated with a third attention weight of each name segment in the POI name vector.

In some embodiments, the POI address model may include a second contextual representation component configured to determine a POI address feature vector of the POI address and a second attention extraction component configured to generate the POI address vector based on the POI address feature vector. The POI address vector may be associated with a fourth attention weight of each address segment of the POI address.

In some embodiments, to generate the third vector representing the POI string based on the POI name vector and the POI address vector, the interactive attention component may be further configured to: determine a similarity matrix between the POI name vector and the POI address vector; determine a fifth attention weight of each name segment with respect to the POI address and a sixth attention weight of each address segment with respect to the POI name based on the similarity matrix; and determine the third vector representing the POI string corresponding to the POI name vector and the POI address based on the fifth attention weight of each name segment and the sixth attention weight of each address segment.

In some embodiments, the text similarity determination model may be trained according to a model training process. The model training process may include obtaining a plurality of search records related to a plurality of historical user queries. Each of the plurality of search records may include a historical recommended search strategy in response to one of the plurality of historical user queries and a user feedback regarding the historical recommended search strategy. The model training process may also include determining a first set of search records with positive user feedbacks from the plurality of search records, and determining a second set of search records with negative user feedbacks from the plurality of search records. The model training process may further include obtaining a preliminary model, and generating the text similarity determination model by training the preliminary model using the first set of search records and the second set of search records.

In some embodiments, the generating the text similarity determination model may further include determining a sample similarity score between the historical user query corresponding to the search record and the corresponding historical recommended search strategy based on the preliminary model for each search record of the first set and the second set. The he generating the text similarity determination model may also include determining a loss function of the preliminary model based on the sample similarity scores corresponding to each search record, and determining the text similarity determination model by minimizing the loss function of the preliminary model.

According to another aspect of the present disclosure, a method for determining at least one recommended search strategy in response to a user query received from a terminal device is provided. The method may include receiving the user query from the terminal device via the data exchange port. The user query may include at least one first segment. The method may also include obtaining a plurality of search strategies matching the user query in response to the user query, and obtaining a text similarity determination model. Each of the plurality of search strategies may include at least one second segment. The text similarity determination model may be adapted to incorporate an attention mechanism. The method may further include for each of the plurality of search strategies, determining a similarity score between a first vector representing the user query and a second vector representing the search strategy. The similarity score may be determined by inputting the user query and the search strategy into the text similarity determination model. At least one of the first vector or the second vector may be associated with an attention weight of each corresponding segment in the corresponding vector, and the attention weight may be determined based on the attention mechanism. The method further include determine the at least one recommended search strategy based on the similarity scores among the plurality of search strategies, and transmitting the at least one recommended search strategy to the terminal device for display.

According to still another aspect of the present disclosure, a system for determining at least one recommended search strategy in response to a user query received from a terminal device is provided. The system may include an obtaining module, a determination module, and a transmission module. The obtaining module may be configured to receive the user query from the terminal device via the data exchange port, obtain a plurality of search strategies matching the user query in response to the user query, and obtain a text similarity determination model. The user query may include at least one first segment. Each of the plurality of search strategies may include at least one second segment. The text similarity determination model may be adapted to incorporate an attention mechanism. The determination module may be configured to, determine a similarity score between a first vector representing the user query and a second vector representing the search strategy for each of the plurality of search strategies, and determine the at least one recommended search strategy based on the similarity scores among the plurality of search strategies. The similarity score may be determined by inputting the user query and the search strategy into the text similarity determination model. At least one of the first vector or the second vector may be associated with an attention weight of each corresponding segment in the corresponding vector. The attention weight may be determined based on the attention mechanism. The transmission module may be configured to transmit the at least one recommended search strategy to the terminal device for display.

According to still another aspect of the present disclosure, a non-transitory computer-readable storage medium embodying a computer program product is provided. The computer program product comprising instructions may be configured to cause a computing device to perform one or more of the following operations. The computing device may receive the user query from the terminal device via the data exchange port. The user query may include at least one first segment. The computing device may also obtain a plurality of search strategies matching the user query in response to the user query. Each of the plurality of search strategies may include at least one second segment. The computing device may also obtain a text similarity determination model. The text similarity determination model may be adapted to incorporate an attention mechanism. For each of the plurality of search strategies, the computing device may determine a similarity score between a first vector representing the user query and a second vector representing the search strategy. The similarity score may be determined by inputting the user query and the search strategy into the text similarity determination model. At least one of the first vector or the second vector may be associated with an attention weight of each corresponding segment in the corresponding vector. The attention weight may be determined based on the attention mechanism. The computing device may also determine the at least one recommended search strategy based on the similarity scores among the plurality of search strategies. The computing device may also transmit the at least one recommended search strategy to the terminal device for display.

Additional features will be set forth in part in the description which follows, and in part will become apparent to those skilled in the art upon examination of the following and the accompanying drawings or may be learned by production or operation of the examples. The features of the present disclosure may be realized and attained by practice or use of various aspects of the methodologies, instrumentalities and combinations set forth in the detailed examples discussed below.

### BRIEF DESCRIPTION OF THE DRAWINGS

The present disclosure is further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 is a schematic diagram illustrating an exemplary O2O service system according to some embodiments of the present disclosure;

FIG. 2 is a schematic diagram illustrating exemplary hardware and/or software components of a computing device according to some embodiments of the present disclosure;

FIG. 3 is a schematic diagram illustrating exemplary hardware and/or software components of a mobile device according to some embodiments of the present disclosure;

FIG. 4A and FIG. 4B are block diagrams illustrating exemplary processing engines according to some embodiments of the present disclosure;

FIG. 5 is a flowchart illustrating an exemplary process for determining at least one recommended search strategy in response to a user query according to some embodiments of the present disclosure;

FIG. 6 is a schematic diagram illustrating an exemplary structure of a text similarity determination model according to some embodiments of the present disclosure;

FIG. 7 is a schematic diagram illustrating an exemplary structure of a first module of a text similarity determination model according to some embodiments of the present disclosure;

FIG. 8 is a schematic diagram illustrating an exemplary structure of a second module of a text similarity determination model according to some embodiments of the present disclosure; and

FIG. 9 is a flowchart illustrating an exemplary process for generating a text similarity determination model according to some embodiments of the present disclosure.

### DETAILED DESCRIPTION

In the following detailed description, numerous specific details are set forth by way of examples in order to provide a thorough understanding of the relevant disclosure. However, it should be apparent to those skilled in the art that the present disclosure may be practiced without such details. In other instances, well-known methods, procedures, systems, components, and/or circuitry have been described at a relatively high-level, without detail, in order to avoid unnecessarily obscuring aspects of the present disclosure. Various modifications to the disclosed embodiments will be readily apparent to those skilled in the art, and the general principles defined herein may be applied to other embodiments and applications without departing from the spirit and scope of the present disclosure. Thus, the present disclosure is not limited to the embodiments shown, but to be accorded the widest scope consistent with the claims.

The terminology used herein is for the purpose of describing particular example embodiments only and is not intended to be limiting. As used herein, the singular forms “a,” “an,” and “the” may be intended to include the plural forms as well, unless the context clearly indicates otherwise. It will be further understood that the terms “comprise,” “comprises,” and/or “comprising,” “include,” “includes,” and/or “including,” when used in this specification, specify the presence of stated features, integers, steps, operations, elements, and/or components, but do not preclude the presence or addition of one or more other features, integers, steps, operations, elements, components, and/or groups thereof.

It will be understood that the terms “system,” “engine,” “module,” “unit,” and/or “block” used herein are one method to distinguish different components, elements, parts, section or assembly of different level in ascending order. However, the terms may be displaced by another expression if they achieve the same purpose.

Generally, the word “module,” “unit,” or “block,” as used herein, refers to logic embodied in hardware or firmware, or to a collection of software instructions. A module, a unit, or a block described herein may be implemented as software and/or hardware and may be stored in any type of non-transitory computer-readable medium or other storage device. In some embodiments, a software module/unit/block may be compiled and linked into an executable program. It will be appreciated that software modules can be callable from other modules/units/blocks or from themselves, and/or may be invoked in response to detected events or interrupts. Software modules/units/blocks configured for execution on computing devices may be provided on a computer-readable medium, such as a compact disc, a digital video disc, a flash drive, a magnetic disc, or any other tangible medium, or as a digital download (and can be originally stored in a compressed or installable format that needs installation, decompression, or decryption prior to execution). Such software code may be stored, partially or fully, on a storage device of the executing computing device, for execution by the computing device. Software instructions may be embedded in a firmware, such as an erasable programmable read-only memory (EPROM). It will be further appreciated that hardware modules/units/blocks may be included in connected logic components, such as gates and flip-flops, and/or can be included of programmable units, such as programmable gate arrays or processors. The modules/units/blocks or computing device functionality described herein may be implemented as software modules/units/blocks, but may be represented in hardware or firmware. In general, the modules/units/blocks described herein refer to logical modules/units/blocks that may be combined with other modules/units/blocks or divided into sub-modules/sub-units/sub-blocks despite their physical organization or storage. The description may be applicable to a system, an engine, or a portion thereof.

It will be understood that when a unit, engine, module, or block is referred to as being “on,” “connected to,” or “coupled to,” another unit, engine, module, or block, it may be directly on, connected or coupled to, or communicate with the other unit, engine, module, or block, or an intervening unit, engine, module, or block may be present, unless the context clearly indicates otherwise. As used herein, the term “and/or” includes any and all combinations of one or more of the associated listed items.

These and other features, and characteristics of the present disclosure, as well as the methods of operations and functions of the related elements of structure and the combination of parts and economies of manufacture, may become more apparent upon consideration of the following description with reference to the accompanying drawings, all of which form a part of this disclosure. It is to be expressly understood, however, that the drawings are for the purpose of illustration and description only and are not intended to limit the scope of the present disclosure. It is understood that the drawings are not to scale.

The flowcharts used in the present disclosure illustrate operations that systems implement according to some embodiments in the present disclosure. It is to be expressly understood, the operations of the flowchart may be implemented not in order. Conversely, the operations may be implemented in inverted order, or simultaneously. Moreover, one or more other operations may be added to the flowcharts. One or more operations may be removed from the flowcharts.

Moreover, while the systems and methods disclosed in the present disclosure are described primarily regarding O2O transportation service, it should also be understood that this is only one exemplary embodiment. The systems and methods of the present disclosure may be applied to any other kind of O2O service or on-demand service. For example, the systems and methods of the present disclosure may be applied to transportation systems including but not limited to land transportation, sea transportation, air transportation, space transportation, or the like, or any combination thereof. A vehicle of the transportation systems may include a rickshaw, travel tool, taxi, chauffeured car, hitch, bus, rail transportation (e.g., a train, a bullet train, high-speed rail, and subway), ship, airplane, spaceship, hot-air balloon, driverless vehicle, or the like, or any combination thereof. The transportation system may also include any transportation system that applies management and/or distribution, for example, a system for sending and/or receiving an express. As another example, the systems and methods of the present disclosure may be applied to a map (e.g., GOOGLE Map, BAIDU Map, TENCENT Map)) navigation system, a meal booking system, an online shopping system, or the like, or any combination thereof.

The application scenarios of different embodiments of the present disclosure may include but not limited to one or more webpages, browser plugins and/or extensions, client terminals, custom systems, intracompany analysis systems, artificial intelligence robots, or the like, or any combination thereof. It should be understood that application scenarios of the system and method disclosed herein are only some examples or embodiments. Those having ordinary skills in the art, without further creative efforts, may apply these drawings to other application scenarios. For example, other similar server.

The terms “passenger,” “requester,” “requestor,” “service requester,” “service requestor,” and “customer” in the present disclosure are used interchangeably to refer to an individual, an entity, or a tool that may request or order a service. Also, the terms “driver,” “provider,” “service provider,” and “supplier” in the present disclosure are used interchangeably to refer to an individual, an entity, or a tool that may provide a service or facilitate the providing of the service. The term “user” in the present disclosure may refer to an individual, an entity, or a tool that may request a service, order a service, provide a service, or facilitate the providing of the service. For example, the user may be a requester, a passenger, a driver, an operator, or the like, or any combination thereof. In the present disclosure, the terms “requester” and “requester terminal” may be used interchangeably, and the terms “provider” and “provider terminal” may be used interchangeably.

The terms “request,” “service,” “service request,” and “order” in the present disclosure are used interchangeably to refer to a request that may be initiated by a passenger, a requester, a service requester, a customer, a driver, a provider, a service provider, a supplier, or the like, or any combination thereof. The service request may be accepted by any one of a passenger, a requester, a service requester, a customer, a driver, a provider, a service provider, or a supplier. The service request may be chargeable or free.

An aspect of the present disclosure relates to systems and methods for determining at least one recommended search strategy (e.g., a point of interest (POI) string) in response to a user query (e.g., a query associated with a location). After receiving a user query from a terminal device, the systems and methods may obtain a plurality of search strategies matching the user query. For each of the plurality of search strategies, the systems and methods may determine a similarity score between a first vector representing the user query and a second vector representing the search strategy based on a text similarity determination model. According to the text similarity determination model, an attention weight of a segment (e.g., a word, a phrase) of the user query or the search strategy in a corresponding vector (i.e., the first vector representing the user query, the second vector representing the search strategy) may be introduced, which may increase the accuracy of the determination of the similarity score between the user query and the search strategy. The systems and methods may also determine, among the plurality of search strategies, at least one recommended search strategy based on the similarity scores. The systems and methods may further transmit the at least one recommended search strategy to the terminal device for display.

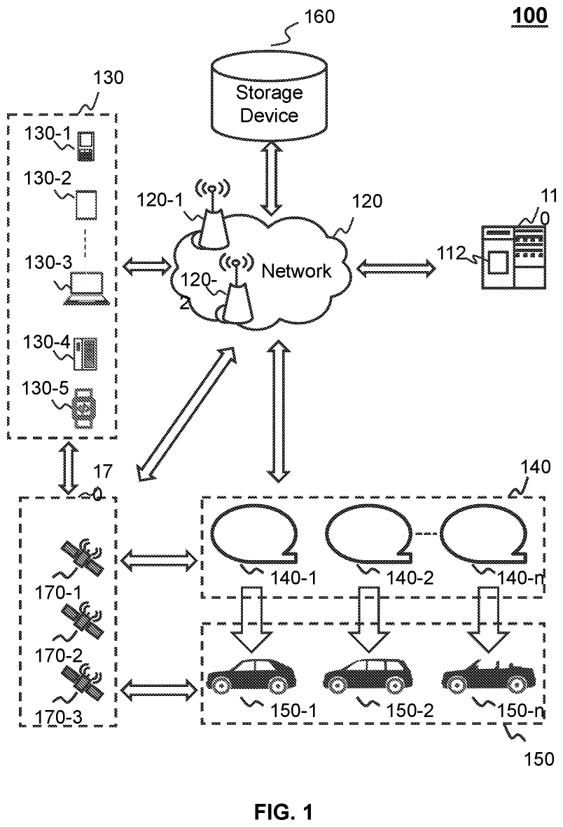

FIG. 1 is a schematic diagram illustrating an exemplary O2O service system according to some embodiments of the present disclosure. For example, the O2O service system 100 may be an online transportation service platform for transportation services. The O2O service system 100 may include a server 110, a network 120, a requester terminal 130, a provider terminal 140, a vehicle 150, a storage device 160, and a navigation system 170.

The O2O service system 100 may provide a plurality of services. Exemplary service may include a taxi-hailing service, a chauffeur service, an express car service, a carpool service, a bus service, a driver hire service, and a shuttle service. In some embodiments, the O2O service may be any online service, such as a map navigation, booking a meal, shopping, or the like, or any combination thereof.

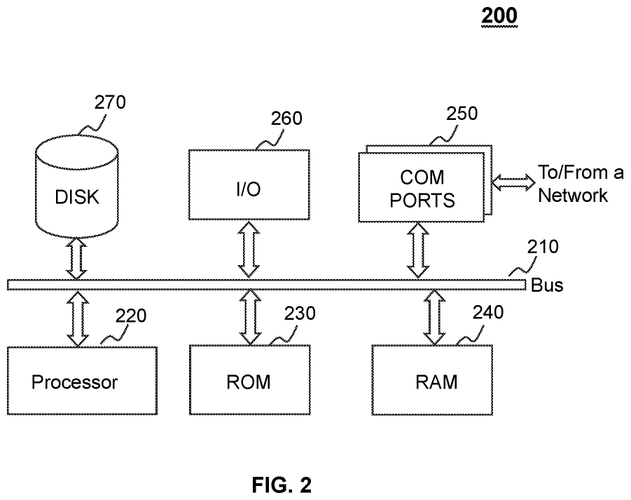

In some embodiments, the server 110 may be a single server or a server group. The server group may be centralized or distributed (e.g., the server 110 may be a distributed system). In some embodiments, the server 110 may be local or remote. For example, the server 110 may access information and/or data stored in the requester terminal 130, the provider terminal 140, and/or the storage device 160 via the network 120. As another example, the server 110 may be directly connected to the requester terminal 130, the provider terminal 140, and/or the storage device 160 to access stored information and/or data. In some embodiments, the server 110 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof. In some embodiments, the server 110 may be implemented on a computing device 200 having one or more components illustrated in FIG. 2 in the present disclosure.

In some embodiments, the server 110 may include a processing engine 112. According to some embodiments of the present disclosure, the processing engine 112 may process information and/or data related to a user query to perform one or more functions described in the present disclosure. For example, the processing engine 112 may process a user query of an O2O service input by a user and/or a plurality of search strategies corresponding to the user query to determine at least one recommended search strategy for the user. In some embodiments, the processing engine 112 may include one or more processing engines (e.g., single-core processing engine(s) or multi-core processor(s)). Merely by way of example, the processing engine 112 may include a central processing unit (CPU), an application-specific integrated circuit (ASIC), an application-specific instruction-set processor (ASIP), a graphics processing unit (GPU), a physics processing unit (PPU), a digital signal processor (DSP), a field-programmable gate array (FPGA), a programmable logic device (PLD), a controller, a microcontroller unit, a reduced instruction-set computer (RISC), a microprocessor, or the like, or any combination thereof.

The network 120 may facilitate exchange of information and/or data. In some embodiments, one or more components of the O2O service system 100 (e.g., the server 110, the requester terminal 130, the provider terminal 140, the vehicle 150, the storage device 160, or the navigation system 170) may transmit information and/or data to other component(s) of the O2O service system 100 via the network 120. For example, the server 110 may receive a user query from a user terminal (e.g., the requester terminal 130) via the network 120. In some embodiments, the network 120 may be any type of wired or wireless network, or combination thereof. Merely by way of example, the network 120 may include a cable network, a wireline network, an optical fiber network, a telecommunications network, an intranet, an Internet, a local area network (LAN), a wide area network (WAN), a wireless local area network (WLAN), a metropolitan area network (MAN), a public telephone switched network (PSTN), a Bluetooth network, a ZigBee network, a near field communication (NFC) network, or the like, or any combination thereof. In some embodiments, the network 120 may include one or more network access points. For example, the network 120 may include wired or wireless network access points such as base stations and/or internet exchange points 120-1, 120-2, through which one or more components of the O2O service system 100 may be connected to the network 120 to exchange data and/or information.

In some embodiments, a passenger may be an owner of the requester terminal 130. In some embodiments, the owner of the requester terminal 130 may be someone other than the passenger. For example, an owner A of the requester terminal 130 may use the requester terminal 130 to transmit a service request for a passenger B or receive a service confirmation and/or information or instructions from the server 110. In some embodiments, a service provider may be a user of the provider terminal 140. In some embodiments, the user of the provider terminal 140 may be someone other than the service provider. For example, a user C of the provider terminal 140 may use the provider terminal 140 to receive a service request for a service provider D, and/or information or instructions from the server 110. In some embodiments, “passenger” and “passenger terminal” may be used interchangeably, and “service provider” and “provider terminal” may be used interchangeably.

In some embodiments, the requester terminal 130 may include a mobile device 130-1, a tablet computer 130-2, a laptop computer 130-3, a built-in device in a vehicle 130-4, a wearable device 130-5, or the like, or any combination thereof. In some embodiments, the mobile device 130-1 may include a smart home device, a smart mobile device, a virtual reality device, an augmented reality device, or the like, or any combination thereof. In some embodiments, the smart home device may include a smart lighting device, a control device of an intelligent electrical apparatus, a smart monitoring device, a smart television, a smart video camera, an interphone, or the like, or any combination thereof. In some embodiments, the smart mobile device may include a smartphone, a personal digital assistance (PDA), a gaming device, a navigation device, a point of sale (POS) device, or the like, or any combination thereof. In some embodiments, the virtual reality device and/or the augmented reality device may include a virtual reality helmet, virtual reality glasses, a virtual reality patch, an augmented reality helmet, augmented reality glasses, an augmented reality patch, or the like, or any combination thereof. For example, the virtual reality device and/or the augmented reality device may include Google™ Glasses, an Oculus Rift™, a HoloLens™, a Gear VR™, etc. In some embodiments, the built-in device in the vehicle 130-4 may include an onboard computer, an onboard television, etc. In some embodiments, the wearable device 130-5 may include a smart bracelet, a smart footgear, smart glasses, a smart helmet, a smart watch, smart clothing, a smart backpack, a smart accessory, or the like, or any combination thereof. In some embodiments, the requester terminal 130 may be a device with positioning technology for locating the position of the passenger and/or the requester terminal 130.

The provider terminal 140 may include a plurality of provider terminals 140-1, 140-2, . . . , 140-n. In some embodiments, the provider terminal 140 may be similar to, or the same device as the requester terminal 130. In some embodiments, the provider terminal 140 may be customized to be able to implement the O2O service system 100. In some embodiments, the provider terminal 140 may be a device with positioning technology for locating the service provider, the provider terminal 140, and/or the vehicle 150 associated with the provider terminal 140. In some embodiments, the requester terminal 130 and/or the provider terminal 140 may communicate with another positioning device to determine the position of the passenger, the requester terminal 130, the service provider, and/or the provider terminal 140. In some embodiments, the requester terminal 130 and/or the provider terminal 140 may periodically transmit the positioning information to the server 110. In some embodiments, the provider terminal 140 may also periodically transmit the availability status to the server 110. The availability status may indicate whether the vehicle 150 associated with the provider terminal 140 is available to carry a passenger. For example, the requester terminal 130 and/or the provider terminal 140 may transmit the positioning information and the availability status to the server 110 every thirty minutes. As another example, the requester terminal 130 and/or the provider terminal 140 may transmit the positioning information and the availability status to the server 110 each time the user logs into the mobile application associated with the O2O service system 100.

In some embodiments, the provider terminal 140 may correspond to one or more vehicles 150. The vehicles 150 may carry the passenger and travel to a destination requested by the passenger. The vehicles 150 may include a plurality of vehicles 150-1, 150-2, . . . , 150-n. One vehicle may correspond to one type of services (e.g., a taxi-hailing service, a chauffeur service, an express car service, a carpool service, a bus service, a driver hire service, or a shuttle service).

In some embodiments, a user terminal (e.g., the requester terminal 130 and/or the provider terminal 140) may send and/or receive information related to an O2O service via a user interface to and/or from the server 110. The user interface may be in the form of an application for the O2O service implemented on the user terminal. The user interface may be configured to facilitate communication between the user terminal and a user (e.g., a driver or a passenger) associated with user terminal. In some embodiments, the user interface may receive an input of a user query for determining a search strategy (e.g., a POI). The user terminal may send the user query for determining a search strategy to the server 110 via the user interface. The server 110 may determine at least one recommended search strategy for the user based on a similarity determination model. The server 110 may transmit one or more signals including the at least one recommended search strategy to the user terminal. The one or more signals including the at least one recommended search strategy may cause the user terminal to display the at least one recommended search strategy via the user interface. The user may select a final search strategy from the at least one recommended search strategy.

The storage device 160 may store data and/or instructions. In some embodiments, the storage device 160 may store data obtained from the requester terminal 130 and/or the provider terminal 140. In some embodiments, the storage device 160 may store data and/or instructions that the server 110 may execute or use to perform exemplary methods described in the present disclosure. In some embodiments, the storage device 160 may include a mass storage, a removable storage, a volatile read-and-write memory, a read-only memory (ROM), or the like, or any combination thereof. Exemplary mass storage may include a magnetic disk, an optical disk, a solid-state drive, etc. Exemplary removable storage may include a flash drive, a floppy disk, an optical disk, a memory card, a zip disk, a magnetic tape, etc. Exemplary volatile read-and-write memory may include a random-access memory (RAM). Exemplary RAM may include a dynamic RAM (DRAM), a double date rate synchronous dynamic RAM (DDR SDRAM), a static RAM (SRAM), a thyristor RAM (T-RAM), and a zero-capacitor RAM (Z-RAM), etc. Exemplary ROM may include a mask ROM (MROM), a programmable ROM (PROM), an erasable programmable ROM (EPROM), an electrically-erasable programmable ROM (EEPROM), a compact disk ROM (CD-ROM), and a digital versatile disk ROM, etc. In some embodiments, the storage device 160 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof.

In some embodiments, the storage device 160 may be connected to the network 120 to communicate with one or more components of the O2O service system 100 (e.g., the server 110, the requester terminal 130, or the provider terminal 140). One or more components of the O2O service system 100 may access the data or instructions stored in the storage device 160 via the network 120. In some embodiments, the storage device 160 may be directly connected to or communicate with one or more components of the O2O service system 100 (e.g., the server 110, the requester terminal 130, the provider terminal 140). In some embodiments, the storage device 160 may be part of the server 110.

The navigation system 170 may determine information associated with an object, for example, one or more of the requester terminal 130, the provider terminal 140, the vehicle 150, etc. In some embodiments, the navigation system 170 may be a global positioning system (GPS), a global navigation satellite system (GLONASS), a compass navigation system (COMPASS), a BeiDou navigation satellite system, a Galileo positioning system, a quasi-zenith satellite system (QZSS), etc. The information may include a location, an elevation, a velocity, or an acceleration of the object, or a current time. The navigation system 170 may include one or more satellites, for example, a satellite 170-1, a satellite 170-2, and a satellite 170-3. The satellites 170-1 through 170-3 may determine the information mentioned above independently or jointly. The navigation system 170 may transmit the information mentioned above to the network 120, the requester terminal 130, the provider terminal 140, or the vehicle 150 via wireless connections.

In some embodiments, one or more components of the O2O service system 100 (e.g., the server 110, the requester terminal 130, the provider terminal 140) may have permissions to access the storage device 160. In some embodiments, one or more components of the O2O service system 100 may read and/or modify information related to the passenger, the service provider, and/or the public when one or more conditions are met. For example, the server 110 may read and/or modify one or more passengers' information after a service is completed. As another example, the server 110 may read and/or modify one or more service providers' information after a service is completed.

One of ordinary skill in the art would understand that when an element (or component) of the O2O service system 100 performs, the element may perform through electrical signals and/or electromagnetic signals. For example, when a requester terminal 130 transmits out a service request to the server 110, a processor of the requester terminal 130 may generate an electrical signal encoding the service request. The processor of the requester terminal 130 may then transmit the electrical signal to an output port. If the requester terminal 130 communicates with the server 110 via a wired network, the output port may be physically connected to a cable, which further may transmit the electrical signal to an input port of the server 110. If the requester terminal 130 communicates with the server 110 via a wireless network, the output port of the requester terminal 130 may be one or more antennas, which convert the electrical signal to electromagnetic signal. Similarly, a provider terminal 140 may receive an instruction and/or service request from the server 110 via electrical signal or electromagnet signals. Within an electronic device, such as the requester terminal 130, the provider terminal 140, and/or the server 110, when a processor thereof processes an instruction, transmits out an instruction, and/or performs an action, the instruction and/or action is conducted via electrical signals. For example, when the processor retrieves or saves data from a storage medium, it may transmit out electrical signals to a read/write device of the storage medium, which may read or write structured data in the storage medium. The structured data may be transmitted to the processor in the form of electrical signals via a bus of the electronic device. Here, an electrical signal may refer to one electrical signal, a series of electrical signals, and/or a plurality of discrete electrical signals.

FIG. 2 is a schematic diagram illustrating exemplary hardware and/or software components of a computing device according to some embodiments of the present disclosure. In some embodiments, the server 110, the requester terminal 130, the provider terminal 140, and/or the storage device 160 may be implemented on the computing device 200. For example, the processing engine 112A and/or the processing engine 112B may be implemented on the computing device 200 and configured to perform functions disclosed in the present disclosure.

The computing device 200 may be configured to implement any component of the O2O service system 100 disclosed in the present disclosure. For example, the processing engine 112A and/or the processing engine 112B may be implemented on the computing device 200, via its hardware, software program, firmware, or any combination thereof. Although only one such computer is shown, for convenience, the computer functions relating to the on-demand service as described herein may be implemented in a distributed fashion on a number of similar platforms to distribute the processing load.

The computing device 200 may include COM ports 250 that may connect with a network that may implement data communications. The computing device 200 may also include a processor 220, in the form of one or more processors (e.g., logic circuits), for executing program instructions. For example, the processor 220 may include interface circuits and processing circuits therein. The interface circuits may be configured to receive electronic signals from a bus 210, wherein the electronic signals encode structured data and/or instructions for the processing circuits to process. The processing circuits may conduct logic calculations, and then determine a conclusion, a result, and/or an instruction encoded as electronic signals. Then the interface circuits may send out the electronic signals from the processing circuits via the bus 210.

The computing device 200 may further include program storage and data storage (e.g., a hard disk 270, a read-only memory (ROM) 230, a random-access memory (RAM) 240) for storing various data files applicable to computer processing and/or communication and/or program instructions executed possibly by the processor 220. The computing device 200 may also include an I/O device 260 that may support the input and output of data flows between computing device 200 and other components. Moreover, the computing device 200 may receive programs and data via the communication network.

Merely for illustration, only one processor is described in FIG. 2. Multiple processors are also contemplated, thus operations and/or method steps performed by one processor as described in the present disclosure may also be jointly or separately performed by the multiple processors. For example, if in the present disclosure the processor of the computing device 200 executes both step A and step B, it should be understood that step A and step B may also be performed by two different CPUs and/or processors jointly or separately in the computing device 200 (e.g., the first processor executes step A and the second processor executes step B, or the first and second processors jointly execute steps A and B).

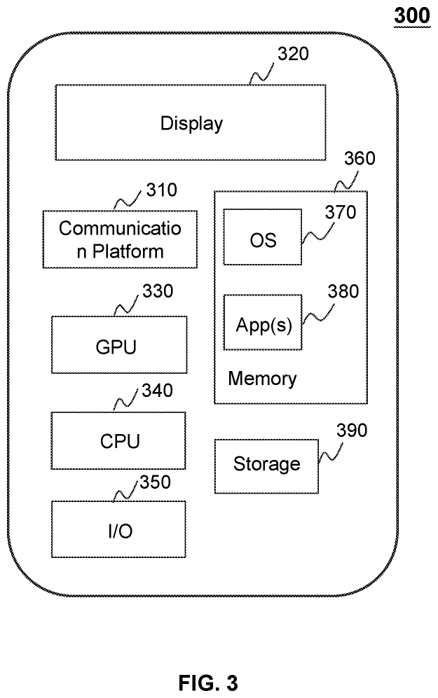

FIG. 3 is a schematic diagram illustrating exemplary hardware and/or software components of a mobile device according to some embodiments of the present disclosure. In some embodiments, the requester terminal 130 and/or the provider terminal 140 may be implemented on the mobile device 300. As illustrated in FIG. 3, the mobile device 300 may include a communication platform 310, a display 320, a graphic processing unit (GPU) 330, a central processing unit (CPU) 340, an I/O 350, a memory 360, a mobile operating system (OS) 370, application (s) 380, and a storage 390. In some embodiments, any other suitable component, including but not limited to a system bus or a controller (not shown), may also be included in the mobile device 300.

In some embodiments, the mobile operating system 370 (e.g., iOS™′ Android™, Windows Phone™, etc.) and one or more applications 380 may be loaded into the memory 360 from the storage 390 in order to be executed by the CPU 340. The applications 380 may include a browser or any other suitable mobile apps for receiving and rendering information relating to O2O services or other information from the O2O service system 100. User interactions with the information stream may be achieved via the I/O 350 and provided to the storage device 160, the server 110 and/or other components of the O2O service system 100.

To implement various modules, units, and their functionalities described in the present disclosure, computer hardware platforms may be used as the hardware platform(s) for one or more of the elements described herein. A computer with user interface elements may be used to implement a personal computer (PC) or any other type of work station or terminal device. A computer may also act as a system if appropriately programmed.

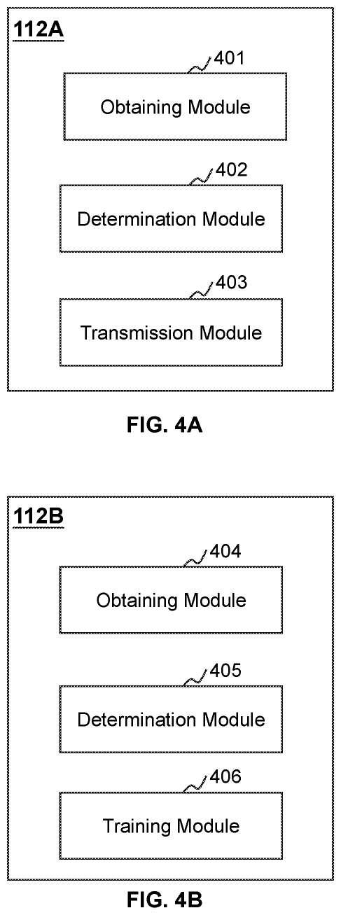

FIG. 4A and FIG. 4B are block diagrams illustrating exemplary processing engines according to some embodiments of the present disclosure. In some embodiments, the processing engines 112A and 112B may be embodiments of the processing engine 112 as described in connection with FIG. 1.

In some embodiments, the processing engine 112A may be configured to determine at least one recommended search strategy corresponding to a user query. The processing engine 112B may be configured to generate a text similarity determination model. In some embodiments, the processing engines 112A and 112B may respectively be implemented on the computing device 200 (e.g., the processor 220) illustrated in FIG. 2 or the CPU 340 illustrated in FIG. 3. Merely by way of example, the processing engine 112A may be implemented on the CPU 340 of a mobile device and the processing engine 112B may be implemented on the computing device 200. Alternatively, the processing engines 112A and 112B may be implemented on the same computing device 200 or the same CPU 340.

The processing engine 112A may include an obtaining module 401, a determination module 402, and a transmission module 403.

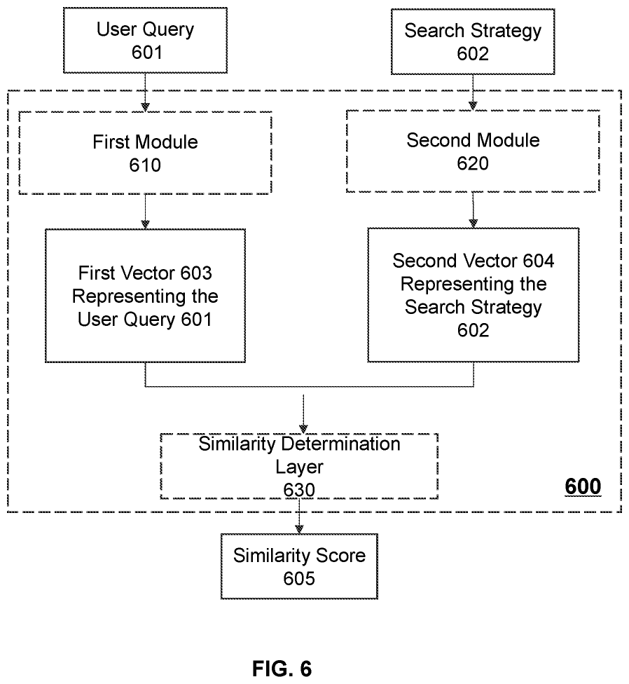

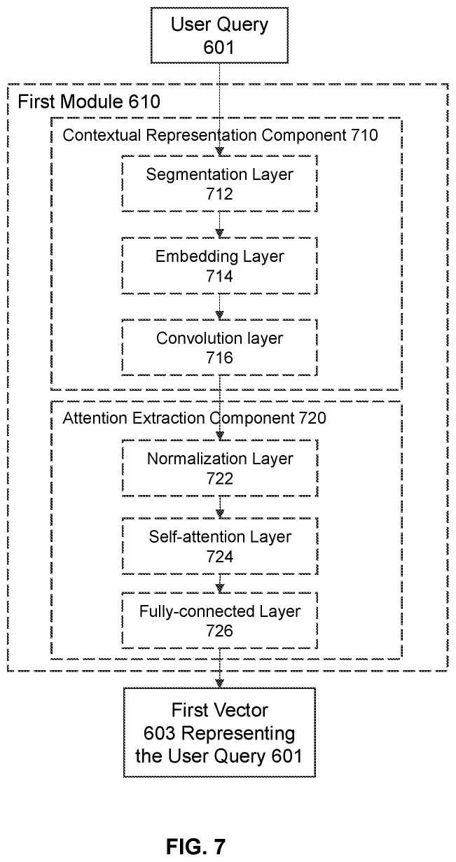

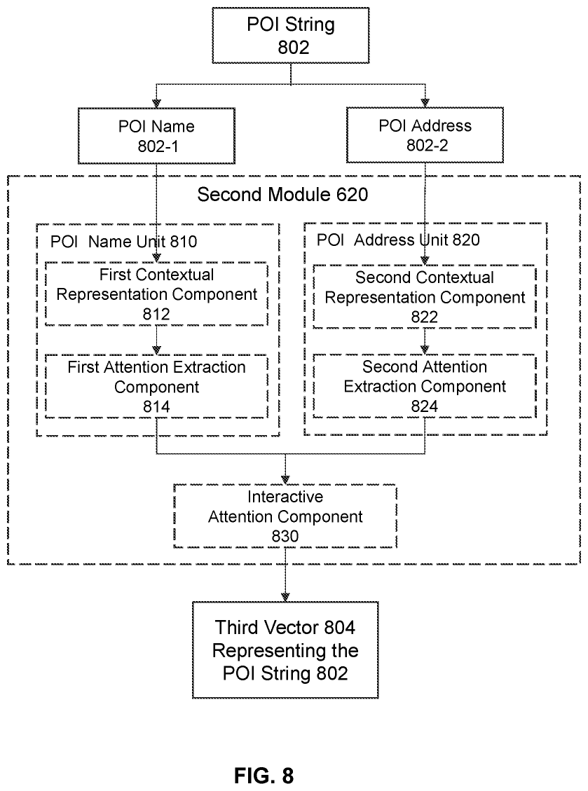

The obtaining module 401 may be configured to obtain information related to one or more components of the O2O service system 100. For example, the obtaining module 401 may receive a user query from a terminal device via a data exchange port. The user query may be associated with an intended location (e.g., a start location or a destination) of a trip, an intended term (e.g., a particular commodity), or any target that the user intends to search for. The data exchange port may establish a connection between the processing engine 112A and one or more other components of the O2O service system 100, such as the requester terminal 130, the provider terminal 140, or the storage device 160. The connection may be a wired connection, a wireless connection, and/or any other communication connection that can enable data transmission and/or reception. In some embodiments, the data exchange port may be similar to the COM ports 250 described in FIG. 2. As another example, the obtaining module 401 may obtain a plurality of search strategies matching the user query in response to the user query. As used herein, a search strategy matching the user query may be associated with a potential search result in response to the user query. As still another example, the obtaining module 401 may obtain a text similarity determination model. The text similarity determination model may be adapted to incorporate an attention mechanism. As used herein, the attention mechanism may refer to a mechanism under which an attention weight (which indicates an importance degree) may be determined for each segment (i.e., the first segment, the second segment) of the user query or the search strategy. The text similarity determination model may be configured to determine a similarity score between a user query and a search strategy matching the user query (during the process for determining the similarity score, the attention weight will be taken into consideration (e.g., see FIGS. 7-8 and the descriptions thereof)). In some embodiments, the obtaining module 401 may obtain the text similarity determination model from the processing engine 112B (e.g., the training module 406) or a storage device (e.g., the storage device 160), such as the ones disclosed elsewhere in the present disclosure. More descriptions of the text similarity determination model may be found elsewhere in the present disclosure (e.g., FIG. 6-8 and the descriptions thereof).

The determination module 402 may be configured to determine a text similarity score between the user query and each of the plurality of search strategies based on the text similarity determination model. For example, the determination module 402 may input the user query and a search strategy into the text similarity determination model and determine a first vector representing the user query and a second vector representing the search strategy based on the text similarity determination model. The determination module 402 may determine the similarity score based on the first vector, the second vector and a similarity algorithm included in the text similarity determination model. Exemplary similarity algorithms may include a Cosine similarity algorithm, a Euclidean distance algorithm, a Pearson correlation coefficient algorithm, a Tanimoto coefficient algorithm, a Manhattan distance algorithm, a Mahalanobis distance algorithm, a Lance Williams distance algorithm, a Chebyshev distance algorithm, a Hausdorff distance algorithm, etc.

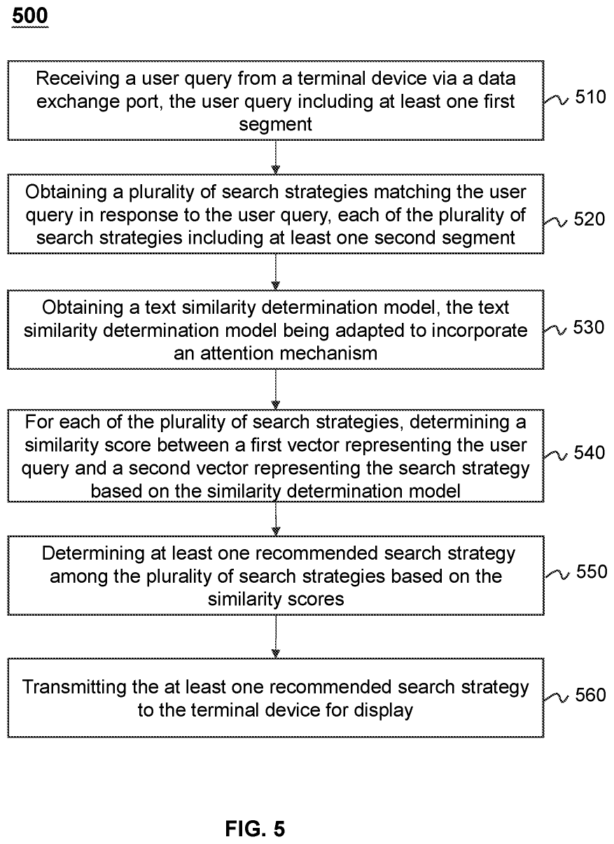

In some embodiments, the determination module 402 may be configured to determine at least one recommended search strategy among the plurality of search strategies based on the similarity scores. For example, the determination module 402 may determine a predetermined threshold and determine one or more recommended search strategies from the plurality of search strategies based on the predetermined threshold. For each of the one or more recommended search strategies, the similarity score may be larger than the predetermined threshold. More descriptions of the determinations of the similarity score and the at least one recommended search strategy may be found elsewhere in the present disclosure (e.g., operation 540-550 in FIG. 5 and the descriptions thereof).

The transmission module 403 may be configured to transmit the at least one recommended search strategy to the terminal device for display. The terminal device may display the at least one recommended search strategy via a user interface (not shown) of the terminal device. In some embodiments, the at least one recommended search strategy may be displayed as a list that is close to an input field for the user query. The user may further select a specific search strategy from the at least one recommended search strategy as a target search strategy matching the user query via the user interface.

The processing engine 112B may include an obtaining module 404, a determination module 405, and a training module 406.

The obtaining module 404 may be configured to obtain information related to training the text similarity determination model. For example, the obtaining module 404 may obtain a plurality of search records related to a plurality of historical user queries. In some embodiments, each of the plurality of search records may include one of the plurality of historical user queries, a historical recommended search strategy in response to the one of the plurality of historical user queries, and a user feedback regarding the historical recommended search strategy. As used herein, the user feedback may refer to a selection of the historical recommended search strategy by the user or not, which means a “positive user feedback” and a “negative user feedback” respectively. As another example, the obtaining module 404 may obtain a preliminary model. The preliminary model may be used for generating the text similarity determination model. The preliminary model may include a preliminary first module, a preliminary second module, and a preliminary similarity determination layer, which may have a plurality of preliminary parameters (as described in connection with FIG. 6).

The determination module 405 may be configured to determine a first set of search records and a second set of search records from the plurality of search records. The first set of search records may be associated with positive user feedbacks. The second set of search records may be associated with negative user feedbacks.

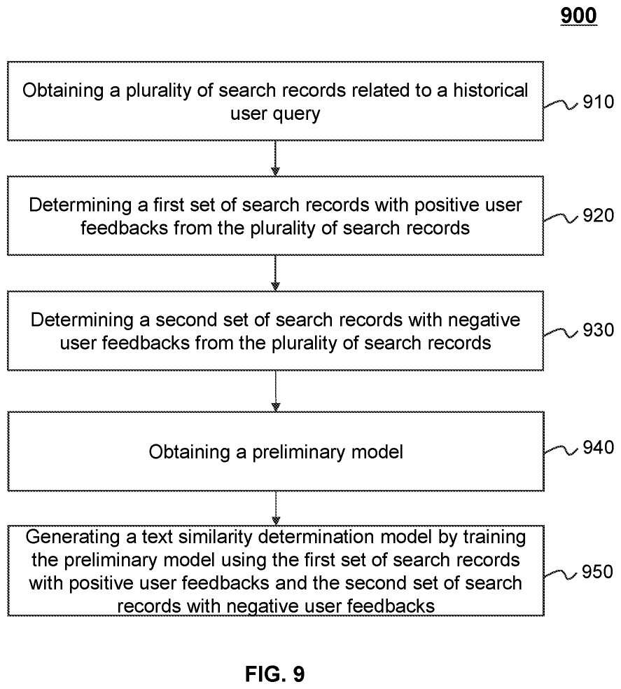

The training module 406 may be configured to train a model. For example, the training module 406 may train the preliminary model using the first set of search records and the second set of search records to generate the text similarity determination model. More descriptions of the generation of the text similarity determination model may be found elsewhere in the present disclosure (e.g., operation 950 in FIG. 9 and the descriptions thereof).

The modules may be hardware circuits of all or part of the processing engine 112. The modules may also be implemented as an application or set of instructions read and executed by the processing engine 112A or the processing engine 112B. Further, the modules may be any combination of the hardware circuits and the application/instructions. For example, the modules may be the part of the processing engine 112A when the processing engine 112A is executing the application/set of instructions.

It should be noted that the above description of the processing engine 112 is provided for the purposes of illustration, and is not intended to limit the scope of the present disclosure. For persons having ordinary skills in the art, multiple variations and modifications may be made under the teachings of the present disclosure. However, those variations and modifications do not depart from the scope of the present disclosure. In some embodiments, the processing engine 112A and/or the processing engine 112B may further include one or more additional modules (e.g., a storage module). In some embodiments, the processing engines 112A and 112B may be integrated as a single processing engine.

FIG. 5 is a flowchart illustrating an exemplary process for determining at least one recommended search strategy in response to a user query according to some embodiments of the present disclosure. In some embodiments, one or more operations of process 500 may be executed by the O2O service system 100. For example, the process 500 may be implemented as a set of instructions (e.g., an application) stored in a storage device (e.g., the storage device 160, the ROM 230, the RAM 240, the storage 390) and invoked and/or executed by the processing engine 112A (e.g., the processor 220 of the computing device 200 and/or the modules illustrated in FIG. 4A). In some embodiments, the instructions may be transmitted in a form of electronic current or electrical signals. The operations of the illustrated process present below are intended to be illustrative. In some embodiments, the process 500 may be accomplished with one or more additional operations not described and/or without one or more of the operations herein discussed. Additionally, the order in which the operations of the process as illustrated in FIG. 5 and described below is not intended to be limiting.

In 510, the processing engine 112A (e.g., the obtaining module 401) (e.g., the interface circuits of the processor 220) may receive a user query from a terminal device (e.g., the requester terminal 130, the provider terminal 140) via a data exchange port (e.g., the COM ports 250). The user query may include at least one first segment (e.g., a word, a phrase). In some embodiments, the user query may be associated with an intended location (e.g., a start location or a destination) of a trip, an intended term (e.g., a particular commodity), or any target that the user intends to search for.

In some embodiments, the user may input the user query via the terminal device (e.g., the requester terminal 130, the provider terminal 140). For example, the user may input the user query in a specific field in an application installed on the terminal device. In some embodiments, the user may input the user query via a typing interface, a hand gesturing interface, a voice interface, a picture interface, etc.

In 520, the processing engine 112A (e.g., the obtaining module 401) (e.g., the processing circuits of the processor 220) may obtain a plurality of search strategies matching the user query in response to the user query, wherein each of the plurality of search strategies may include at least one second segment (e.g., a word, a phrase). As used herein, a search strategy matching the user query may be associated with a potential search result in response to the user query.

Take a user query associated with an intended location as an example, the search strategy may be a point of interest (POI) string including a POI name and/or a POI address. Accordingly, the at least one second segment in the search strategy may include at least one name segment (e.g., a word or a phrase in the POI name) and/or at least one address segment (e.g., a word or a phrase in the POI address).

In some embodiments, the processing engine 112A may determine at least one of a prefix, a key term, or a phrase in the user query and determine the plurality of search strategies matching the user query based on the prefix, the key term, or the phrase. For example, it is assumed that the user query includes a key term “central business district,” the processing engine 112A may determine the plurality of search strategies matching the user query such as “Central Business District Subway Station,” “Central Business District Building,” etc.

In some embodiments, the processing engine 112A may pre-process the user query and determine the plurality of search strategies matching the user query based on the processed user query. For example, the processing engine 112A may rewrite the user query (e.g., “Central Business District”) as a synonym (e.g., “CBD”). As another example, the processing engine 112A may analyze the user query to determine whether the user query is misspelled. If the analysis result indicates that the user query is misspelled, the processing engine 112A may process the user query by correcting the spelling. In some embodiments, the processing engine 112A may rewrite and/or correct the user query based on a noise channel model, a Bayes classifier, a maximum entropy model, or the like, or any combination thereof.

In 530, the processing engine 112A (e.g., the obtaining module 401) (e.g., the interface circuits of the processor 220) may obtain a text similarity determination model, wherein the text similarity determination model is adapted to incorporate an attention mechanism. As used herein, the attention mechanism may refer to a mechanism under which an attention weight (which indicates an importance degree) may be determined for each segment (i.e., the first segment, the second segment) of the user query or the search strategy. The text similarity determination model may be configured to determine a similarity score between the user query and a search strategy matching the user query (during the process for determining the similarity score, the attention weight will be taken into consideration (e.g., see FIGS. 7-8 and the descriptions thereof)). The similarity score may indicate a similarity between the user query and the search strategy. The larger the similarity score is, the higher the similarity between the user query and the search strategy may be.

In some embodiments, the processing engine 112A may obtain the text similarity determination model from the processing engine 112B (e.g., the training module 406) or a storage device (e.g., the storage device 160), such as the ones disclosed elsewhere in the present disclosure. In some embodiments, the training module 406 may generate the text similarity determination model by training a preliminary model with a plurality of search records associated with a plurality of historical user queries. More descriptions of the training process may be found elsewhere in the present disclosure (e.g., FIG. 9 and the description thereof).

In 540, for each of the plurality of search strategies, the processing engine 112A (e.g., the determining module 402) (e.g., the processing circuits of the processor 220) may determine a similarity score between a first vector (e.g., 603 illustrated in FIG. 6) representing the user query and a second vector (e.g., 604 illustrated in FIG. 6) representing the search strategy based on the text similarity determination model.

In some embodiments, the first vector may be a vector indicating one or more features of the user query. In some embodiments, the feature of the user query may include a local feature, a global feature, etc. The local feature may refer to a feature of a portion of the user query. For example, the local feature may include a feature related to context information and/or semantic information of each first segment of the user query. The global feature may refer to a feature related to the whole user query. For example, the global feature may include an attention weight of each first segment with respect to the user query. Similarly, the second vector may be a vector indicating one or more features of the search strategy. In some embodiments, the feature of the search strategy may include a local feature (e.g., a feature related to context information and/or semantic information of each second segment), a global feature (e.g., an attention weight of each second segment with respect to the search strategy), an interactive feature, etc. As described in connection with operation 520, the search strategy may be a POI string including a POI name and a POI address. The interactive feature may refer to a feature related to a relationship between the POI name and the POI address. For example, the interactive feature may include an attention weight of each name segment with respect to the POI address, an attention weight of each address segment with respect to the POI name, etc. More descriptions regarding the local feature, the global feature, and the interactive feature may be found elsewhere in the present disclosure (e.g., FIGS. 6-8 and the relevant descriptions thereof).

In some embodiments, the dimension of the first vector may be the same as that of the second vector. In some embodiments, the types of features indicated by the first vector may be the same as or different from the types of features indicated by the second vector. For example, for a user query associated with an intended term (e.g., a particular commodity), the search strategy may be a term string. In this situation, both of the first vector representing the user query and the second vector representing the search strategy may indicate a local feature and a global feature. As another example, for a user query associated with an intended location, the search strategy may be a POI string including a POI name and a POI address. In this situation, the first vector representing the user query may indicate a local feature and a global feature, and the second vector representing the search strategy may indicate a local feature, a global feature, and an interactive feature.

In some embodiments, the processing engine 112A may input the user query and a search strategy into the text similarity determination model and determine the first vector representing the user query and the second vector representing the search strategy based on the text similarity determination model. In some embodiments, as described in connection with operation 530, at least one of the first vector and/or the second vector may be associated with the attention weight of each corresponding segment (i.e., the first segment, the second segment) in the corresponding vector. For example, for the first vector representing the user query, importance degrees of different first segments included in the user query may be different. Accordingly, different first segments of the user query may have different attention weights on the first vector. Further, the processing engine 112A may determine the first vector based on the different attention weights of the first segments. Similarly, for the second vector representing the search strategy, importance degrees of different second segments included in the search strategy may be different. Accordingly, different second segments of the search strategy may have different attention weights on the second vector. Further, the processing engine 112A may determine the second vector based on the different attention weights of the second segments. More descriptions of the attention weight may be found elsewhere in the present disclosure (e.g., FIG. 7 and the description thereof).

After determining the first vector and the second vector, the processing engine 112A may determine the similarity score between the first vector and the second vector based on a similarity algorithm included in the text similarity determination model, for example, a Cosine similarity algorithm, a Euclidean distance algorithm, a Pearson correlation coefficient algorithm, a Tanimoto coefficient algorithm, a Manhattan distance algorithm, a Mahalanobis distance algorithm, a Lance Williams distance algorithm, a Chebyshev distance algorithm, a Hausdorff distance algorithm, etc. More descriptions of determining the similarity score may be found elsewhere in the present disclosure (e.g., FIG. 6 and the description thereof).

In 550, the processing engine 112A (e.g., the determination module 402) (e.g., the processing circuits of the processor 220) may determine at least one recommended search strategy among the plurality of search strategies based on the similarity scores. In some embodiments, the processing engine 112A may determine a predetermined threshold and determine one or more recommended search strategies from the plurality of search strategies based on the predetermined threshold, wherein for each of the one or more recommended search strategies, the similarity score is larger than the predetermined threshold. In some embodiments, the processing engine 112A may rank the plurality of search strategies based on the similarity scores corresponding to the plurality of search strategies according to a predetermined order (e.g., ascending order, descending order). For example, the larger the similarity score is, the higher the ranking of a corresponding search strategy may be. Further, the processing engine 112A may determine one or more recommended search strategies (e.g., top 1, top 2, top 5, top 10, top 1%, top 5%, top 10%) from the plurality of search strategies based on the ranking result.

In 560, the processing engine 112A (e.g., the transmission module 403) (e.g., the interface circuits of the processor 220) may transmit the at least one recommended search strategy to the terminal device for display. The terminal device may display the at least one recommended search strategy via a user interface (not shown) of the terminal device. In some embodiments, the at least one recommended search strategy may be displayed as a list that is close to an input field for the user query. The user may further select a specific search strategy from the at least one recommended search strategy as a target search strategy matching the user query via the user interface.

It should be noted that the above description regarding the process 500 is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. In some embodiments, one or more operations may be omitted and/or one or more additional operations may be added. For example, after operation 560, the processing engine 112A may receive a feedback from the terminal device if there is no search strategy is selected by the user from the at least one recommended search strategy. In some embodiments, the feedback may be used for updating the text similarity determination model. As another example, one or more other optional steps (e.g., a storing step) may be added elsewhere in the process 500. In the storing step, the processing engine 112A may store information (e.g., the search strategies, the similarity scores) associated with the user query in a storage device (e.g., the storage device 160), such as the ones disclosed elsewhere in the present disclosure.

FIG. 6 is a schematic diagram illustrating an exemplary structure of a text similarity determination model according to some embodiments of the present disclosure. As described elsewhere in the present disclosure, the text similarity determination model 600 may be configured to determine a similarity score 605 between a user query 601 and a search strategy 602. As illustrated in FIG. 6, the text similarity determination model 600 may include a first module 610, a second module 620, and a similarity determination layer 630.

The first module 610 may be configured to generate a first vector 603 representing the user query 601. As described in connection with operation 540, the first module 610 may extract features (e.g., a local feature, a global feature) of the user query 601 and generate the first vector 603 indicating the features. For example, the first module 610 may segment the user query 601 into one or more first segments and extract the local feature (e.g., the context information and/or the semantic information of each first segment) of the user query 601; moreover, the first module 610 may extract the global feature of the user query 601, for example, determine an attention weight (also referred to as “first attention weight”) of each first segment with respect to the user query 601. Further, the first module 610 may generate the first vector 603 based on the local feature and the global feature of the user query 601. More descriptions of the first module 610 may be found elsewhere in the present disclosure (e.g., FIG. 7 and the descriptions thereof).

The second module 620 may be configured to generate a second vector 604 representing the search strategy 602. As described in connection with operation 540, the second module 620 may extract features (e.g., a local feature, a global feature, and/or an interactive feature) of the search strategy 602 and generate the second vector 604 indicating the features.

For example, it is assumed that the search strategy 602 is a term string (which corresponds to a user query associated with an intended term (e.g., a particular commodity)), the second module 620 may segment the search strategy 602 into one or more second segments and extract the local feature of the search strategy 602; moreover, the second module 620 may extract the global feature of the search strategy 602, for example, determine an attention weight of each second segment with respect to the search strategy 602. Further, the second module 620 may generate the second vector 604 based on the local feature and the global feature of the search strategy 602.

As another example, it is assumed that the search strategy 602 is a POI string (which corresponds to a user query associated with an intended location) including a POI name and a POI address, the second module 620 may generate a POI name vector based on a local feature and a global feature (e.g., an attention weight (also referred to as “third attention weight”) of each name segment with respect to the POI name) of the POI name, and a POI address vector based on a local feature and a global feature (e.g., an attention weight (also referred to as “fourth attention weight”) of each address segment with respect to the POI address) of the POI address. The second module 620 may also extract an interactive feature of the POI string, for example, determine an attention weight (also referred to as “fifth attention weight”) of each name segment with respect to the POI address and/or an attention weight (also referred to as “sixth attention weight”) of each address segment with respect to the POI name. Further, the second module 620 may determine the second vector 604 based on the local feature, the global feature, and the interactive feature of the search strategy 602. More descriptions of the second module 620 that is used to process a POI string may be found elsewhere in the present disclosure (e.g., FIG. 8 and the descriptions thereof).

In some embodiments, the dimension of the second vector 604 may be the same as that of the first vector 603. For example, it is assumed that the first vector 603 is an N-dimensional vector and the second vector 604 is an M-dimensional vector, then M may be equal to N. In some embodiments, M and N are integers and may be default settings of the O2O service system 100 or be adjustable in different situations. More descriptions of the second module 620 may be found elsewhere in the present disclosure (e.g., FIG. 8 and the descriptions thereof).

The similarity determination layer 630 may be configured to determine the similarity score 605 between the first vector 603 and the second vector 604. In some embodiments, the similarity determination layer 630 may determine a cosine similarity between the first vector 603 and the second vector 604 according to Equation (1) below:

$$Cosine ( q , d ) = \frac{q \cdot d}{‖ q ‖ \cdot ‖ d ‖} , \qquad ( 1 )$$

where q refers to the first vector 603, d refers to the second vector 604, Cosine(q, d) refers to the cosine similarity between the first vector 603 and the second vector 604, q·d refers to a dot product of the first vector 603 and the second vector 604, and ∥q∥·∥d∥ refers to a product of the length of the first vector 603 and the length of the second vector 604.

It should be noted that the above description of the text similarity determination model 600 is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. For example, in order to determine the similarity score 605 between the first vector 603 and the second vector 604, the similarity determination layer 630 may perform a full connection operation on the first vector 603 and the second vector 604, wherein a result (i.e., the similarity score) of the full connection operation may be a value in a range from 0 to 1, the larger the value is, the higher the similarity between the first vector 603 and the second vector 604 may be.

FIG. 7 is a schematic diagram illustrating an exemplary structure of a first module of a text similarity determination model according to some embodiments of the present disclosure. As described in connection with FIG. 6, the first module 610 of the text similarity determination model 600 may be configured to generate the first vector 603 representing the user query 601. As illustrated in FIG. 7, the first module 610 may include a contextual representation component 710 and an attention extraction component 720.

The contextual representation component 710 may be configured to determine a first feature vector of the user query 601. The first feature vector may be a vector indicating context information of the user query 601. As used here, the “context information” refers to information associated with the sequence of the at least one first segment in the user query 601, for example, correlation information among the at least one first segment. Take a specific word in the user query 601 as an example, the context information may include correlation information among the word and one or more previous first segments along the sequence of the at least one first segment and/or correlation information among the word and one or more subsequent first segments along the sequence. In some embodiments, the contextual representation component 710 may include a segmentation layer 712, an embedding layer 714, and a convolution layer 716.

The segmentation layer 712 may be configured to segment the user query 601 into the at least one first segment. As described elsewhere in the present disclosure, the at least one first segment may include one or more word segments and one or more phrase segments. In some embodiments, the segmentation layer 712 may segment the user query 601 based on a semantic rule, such as a corpus-based rule or a statistic-based rule. For example, the segmentation layer 712 may match the user query 601 with words and phrases in a thesaurus or a corpus database based on the corpus-based rule to determine the at least one first segment. As another example, the segmentation layer 712 may segment the user query 601 based on an N-gram Model or a Hidden Markov Model (HMM) based on the statistic-based rule to determine the at least one first segment.

The embedding layer 714 may be configured to generate a word embedding of the user query 601. As used herein, the word embedding may be a real-number vector or matrix indicating semantic information and/or context information of the user query 601. The embedding layer 714 may generate the word embedding of the user query 601 based on a vocabulary including a plurality of words and phrases (also can be collectively referred to as “a plurality of cells”). The vocabulary may correspond to a matrix and each of the plurality of cells in the vocabulary corresponds to a row of the matrix (also referred to as a “row vector”), that is, each of the plurality of cells can be represented by a row vector. Generally, the row vector is a high-dimensional vector which can be transformed as a two-dimensional vector. It is known that a two-dimensional vector corresponds to a point in a rectangular coordinate system. In this situation, a distance between two points in the rectangular coordinate system indicates a similarity between two cells represented by the two-dimensional vectors, the smaller the distance between the two points is, the higher the similarity between the two corresponding cells may be.

In some embodiments, for each of the at least one first segment included in the user query 601, the embedding layer 714 may identify a corresponding cell (e.g., a word or a phrase) in the vocabulary and determine a corresponding row (i.e., a row vector) of the matrix as the word embedding of the first segment. Further, the embedding layer 714 may combine the row vectors corresponding to the at least one first segment to determine the word embedding of the user query 601. For example, it is assumed that there are m first segments in the user query 601 and each first segment corresponds to an N-dimensional row vector. The embedding layer 714 may combine m row vectors into a 1×(m×N) row vector or an m×N matrix (i.e., the word embedding), where m and N are integers.

In some embodiments, the embedding layer 714 may first combine the first segments as a “phrase” in a certain manner. For each of the first segments, the embedding layer 714 may further identify a corresponding cell of the first segment in the “phrase” in the vocabulary, and determine the row vector corresponding to the cell as the word embedding of the first segment. The embedding layer 714 may then combine the row vectors of the first segments according to the certain manner for generating the “phrase”, wherein the combined row vectors may be regarded as the word embedding of the user query 601. For example, the embedding layer 714 may combine the first segments into the “phrase” in a certain sequence, and the embedding layer 714 may combine the row vectors into the word embedding of the user query 601 in the same sequence.

It should be noted that the above descriptions regarding the determination of the word embedding of the user query 601 are provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. Merely by way of example, the word embedding of the first segment may be represented by a column vector.

The convolution layer 716 may be configured to perform a convolution operation on the word embedding of the user query 601 and determine the first feature vector indicating the context information of the user query 601 based on the word embedding. In some embodiments, the convolution layer 716 may include a plurality of channels. Each of the plurality of channels may be configured to extract a particular feature from the word embedding. Different channels may extract different features from the word embedding. Each of the plurality of channels may correspond to a kernel. The kernels corresponding to the plurality of channels may include same parameters (e.g., same widths and same heights such as 2×100). In some embodiments, the width of the kernel may be the same as the width of the word embedding of the user query 601. The height of the kernel may be default settings of the O2O service system 100 or may be adjustable in different situations.

The attention extraction component 720 may be configured to generate the first vector 603 based on the first feature vector of the user query 601. As described elsewhere in the present disclosure, the first vector 603 may be associated with a first attention weight of each first segment (which indicates an importance degree of the first segment to the user query 601) in the first vector 603. The attention extraction component 720 may determine the first attention weight of each first segment and generate the first vector 603 based on the attention weight(s) corresponding to the at least one first segment and the first feature vector. In some embodiments, the attention extraction component 720 may include a normalization layer 722, a self-attention layer 724, and a fully-connected layer 726.

The normalization layer 722 may be configured to normalize the first feature vector of the user query 601 to determine a normalized first feature vector. During the training process of the first module 610, using the normalized first feature vector can improve accuracy and/or speed up convergence of the first module 610.

The self-attention layer 724 may be configured to incorporate an attention mechanism and determine the first attention weight of each first segment in the normalized first feature vector based on the attention mechanism. The first attention weight of a first segment may be any measurement (e.g., a coefficient or a vector) that can reflect the importance degree of the first segment in the user query 601. In some embodiments, the user query 601 may be regarded as a set including one or more data pairs, wherein each of the one or more data pairs can be expressed as <key, value>. As used herein, the “key” refers to a first segment, and the “value” of the “key” corresponds to a portion of the normalized first feature vector corresponding to the first segment. Take a specific first segment as an example, the self-attention layer 724 may first determine a correlation (or similarity) between the specific first segment and each of all the first segments of the user query 601. The self-attention layer 724 may determine the correlation (or similarity) between two first segments based on, for example, a dot product, a cosine similarity, or a multilayer perceptron similarity between the values of the two first segments. The self-attention layer 724 may further determine the first attention weight of the specific first segment based on the correlations (or similarities) between the specific first segment and all the first segments. Additionally or alternatively, the self-attention layer 724 may generate a modified first feature vector based on the normalized first feature vector and the first attention weight of each first segment.

Merely by way of example, the self-attention layer 724 may assign a coefficient (e.g., a coefficient in a range of 0 to 1) to the specific first segment as its first attention weight based on the correlations (or similarities) between the specific first segment and all the first segments. The coefficient may have a positive relationship with, for example, an average correlation (or similarity) between the specific first segment and all the first segments. In the determination of the modified first feature vector, the self-attention layer 724 may multiply the value of the specific first segment with the corresponding first attention weight to determine a modified value of the specific first segment. Further, self-attention layer 724 may determine the modified first feature vector by combining the modified values of all the first segments of the user query 601.

As another example, the self-attention layer 724 may normalize the correlations (or similarities) between the specific first segment and all the first segments and determine a weight for the value of each first segment of the user query 601, wherein for each first segment, the weight represents an importance degree of the first segment to the specific first segment and equals to a normalized correlation (or similarity) between the first segment and the specific first segment. In the determination of the modified first feature vector, the self-attention layer 724 may determine a weight sum of the values of all the first segments based on the weights corresponding to the first segments and determine the weight sum as a modified value of the specific first segment. In such cases, the first attention weight of the specific first segment may be a vector including the weights corresponding to the first segments. Further, self-attention layer 724 may determine the modified first feature vector by combining the modified values of all the first segments of the user query 601.

For illustration purposes, an example of a user query 601 including segments A, B, and C is described as an example. The values of the segments A, B, and C are denoted as V_{A}, V_{B}, and V_{C}, respectively. For the segment A, the self-attention layer 724 may determine a correlation (or similarity) between the segment A and each of the segments A, B, and C, which can be expressed as C_{A}, C_{B}, and C_{C}. The self-attention layer 724 may normalize the correlations (or similarities) C_{A}, C_{B}, and C_{C} and determine the normalized correlations (or similarities) C_{A}′, C_{B}′, and C_{C}′ as weights for the values of the segments A, B, and C respectively. That is, for the segment A, the first attention weight is a vector including the normalized correlations (or similarities) C_{A}′, C_{B}′, and C_{C}′ (i.e., a vector (C_{A}′, C_{B}′, C_{C}′)). The self-attention layer 724 may determine a weight sum of the values of the segments A, B, and C based on the weights (i.e., C_{A}′·V_{A}+C_{B}′·V_{B}+C_{C}′·V_{C}) and determine the weight sum as a modified value of the segment A. Further, the self-attention layer 724 may determine the modified first feature vector by combining the modified values of all the segments A, B, and C of the user query 601.

In some embodiments, the self-attention layer 724 may determine the modified first feature vector according to Equation (2) illustrated below:

$$Attention ( Q , K , V ) = softmax ( \frac{{QK}^{T}}{\sqrt{{d}_{k}}} ) V , \qquad ( 2 )$$

where Attention (Q, K, V) refers to the modified first feature vector, Q refers to a matrix packed by a plurality of target elements whose attention weights to be determined (i.e., the first segments), K refers a matrix packed by the keys in the data pairs of the user query 601 (i.e., the first segments), and V refer to a matrix packed by the values in the data pairs of the user query 601 (i.e., the values of the first segments), dₖ refers to the dimension of Q, K, or V (which represents the length of the user query 601), QK^{T} refers to a dot product of Q and K, and softmax refers to a function for normalization. In some embodiments, the value of Q and K may be equal to the value of V. In some embodiments, the values of the first segments may be row vectors, and the row vectors may be packed (or combined) into the matrix Q, the matrix K, and the matrix V, respectively. In some embodiments,

$$softmax ( \frac{{QK}^{T}}{\sqrt{{d}_{k}}} )$$

may be a matrix (referred to as “first attention weight matrix”) including the first attention weights of the first segments in the user query 601, wherein a first attention weight corresponds to a vector in the matrix.

In some embodiments, the self-attention layer 724 may perform a single time of attention mechanism (e.g., according to Equation (2)). Alternatively, the self-attention layer 724 may incorporate a multi-head self-attention mechanism, under which the Q, K, and V are linearly projected (i.e., linearly transformed) h times, respectively. For each projected version of Q, K, and V, the self-attention layer 724 may perform an attention mechanism (e.g., according to Equation (2)) in parallel to generate an output (e.g., the Attention (Q, K, V) in Equation (2)). The self-attention layer 724 may further concatenate the output of the each projected version of Q, K, and V, and optionally perform a linear projection on the concatenated output. The concatenated output after linear projection may be regarded as the modified first feature vector.

The fully-connected layer 726 may be configured to process the modified first feature vector to determine the first vector 603 representing the user query 601. In some embodiments, the fully-connected layer 726 may process the modified first feature vector by reducing dimensions or raising dimensions thereof, making the processed modified first feature vector (i.e., the first vector 603) representing the user query 601 to have the same number of dimensions as the second vector 602 representing the search strategy 602 for further determining the similarity score 605.

It should be noted that the above description of the first module is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. In some embodiments, one or more components may be added or omitted in the first module 610. For example, the fully-connected layer 726 may be omitted. The self-attention layer 724 may determine the first vector 603 representing the user query 601 based on the normalized first feature and the first attention weight.

FIG. 8 is a schematic diagram illustrating an exemplary structure of a second module of a text similarity determination model according to some embodiments of the present disclosure. As described in connection with FIG. 6, the second module 620 of the text similarity determination model 600 may be configured to generate the second vector 604 representing the search strategy 602. As described in connection with operation 510, the user query 601 may be associated with an intended location (e.g., a start location, a destination), accordingly, the search strategy 602 may be a POI string 802. In such situation, the second module 620 may be configured to determine a third vector 804 representing the POI string 802. As illustrated in FIG. 8, the POI string 802 may include a POI name 802-1 and a POI address 802-2. Accordingly, the second module 620 may include a POI name unit 810, a POI address unit 820, and an interactive attention component 830.

As described elsewhere in the present disclosure, the search strategy 602 may include at least one second segment. For the POI string 802, the at least one second segment may include at least one name segment of the POI name 802-1 and at least one address segment of the POI address 802-2. For example, it is assumed that the POI string 802 is “Metropolitan Museum of Art, 1000 5th Ave New York,” then the POI name 802-1 is “Metropolitan Museum of Art” and the POI address 802-2 is “1000 5th Ave New York.” Accordingly, a name segment may be a word or a phrase in “Metropolitan Museum of Art” and an address segment may be a word or a phrase in “1000 5th Ave New York.”

The POI name unit 810 may be configured to determine a POI name vector (not shown in FIG. 8) representing the POI name 802-1 based on the at least one name segment. The POI name unit 810 may include a first contextual representation component 812 and a first attention extraction component 814. The first contextual representation component 812 may be configured to determine a name feature vector of the POI name 802-1. In some embodiments, the first contextual representation component 812 may be the same as or similar with the contextual representation component 710 and the description thereof may not be repeated. The first attention extraction component 814 may be configured to determine the POI name vector representing the POI name 802-1 based on the name feature vector of the POI name 802-1. The POI name vector may be associated with a third attention weight of each name segment in the POI name vector. The third attention weight of each name segment of the POI name 802-1 may indicate an importance degree of each name segment to the POI name 802-1. The third attention weight of each name segment of the POI name 802-1 may be similar to the first attention weight of each first segment of the user query 601 as described in connection with FIG. 7 and the descriptions thereof are not repeated. In some embodiments, the first attention extraction component 814 may be the same as or similar with the attention extraction component 720 and the description thereof may not be repeated.

The POI address unit 820 may be configured to determine a POI address vector (not shown in FIG. 8) representing the POI address 802-2 based on the at least one address segment. The POI address unit 820 may include a second contextual representation component 822 and a second attention extraction component 824. The second contextual representation component 822 may be configured to determine a feature vector of the POI address 802-2. In some embodiments, the second contextual representation component 822 may be the same as or similar with the contextual representation component 710 and the description thereof may not be repeated. The second attention extraction component 824 may be configured to determine the POI address vector representing the POI address 802-2 based on the feature vector of the POI address 802-2. The POI address vector may be associated with a fourth attention weight of each address segment of the POI address. The fourth attention weight of each address segment of the POI address 802-2 may indicate an importance degree of each address segment to the POI address 802-2. The fourth attention weight of each address segment of the POI address 802-2 may be similar to the first attention weight of each first segment of the user query 601 as described in connection with FIG. 7 and the descriptions thereof are not repeated. In some embodiments, the second attention extraction component 824 may be the same as or similar with the attention extraction component 720 and the description thereof may not be repeated.

In some embodiments, the interactive attention component 830 may be configured to generate the third vector 804 representing the POI string 802 based on the POI name vector and the POI address vector. The third vector 804 may be associated with a second attention weight of each name segment and each address segment (collectively referred to as “second segment”) in the third vector 804. The second attention weight of each name segment and each address segment in the third vector 804 may indicate an importance degree of each name segment and each address segment to the POI string 802.

In some embodiments, the interactive attention component 830 may be configured to determine an interactive attention weight (referred to as a “fifth attention weight”) for each name segment with respect to the POI address and an interactive attention weight (referred to as a “sixth attention weight”) for each address segment with respect to the POI name, and determine the third vector 804 based on the interactive attention weights. For each name segment of the POI name, the fifth attention weight with respect to the POI address may indicate an importance degree of each address segment of the POI address to the name segment. For each address segment of the POI address, the six attention weight with respect to the POI name may indicate an importance degree of each name segment of the POI name to the address segment. As described in connection with FIG. 7, a fifth attention weight of a name segment with respect to the POI address or a six attention weight of an address segment with respect to the POI name may be similar to the first attention weight of a first segment with respect to the user query 601.

In some embodiments, the interactive attention component 830 may determine a similarity matrix between the POI name vector and the POI address vector and determine the fifth attention weight and the sixth attention weight based on the similarity matrix. For example, the interactive attention component 830 may determine the similarity matrix between the POI name vector and the POI address vector according to Equation (3) illustrated below:

Sₜⱼ=α(H_{:t},U_{:j})∈R, (3)

where Sₜⱼ refers to a similarity between a t-th name segment in the POI name vector and a j-th address segment in the POI address vector, H refers to a first matrix representing the POI name, H_{:t} refers to a t-th column vector of H, U refers to a second matrix representing the POI address, U_{:j} refers to a j-th column vector of U, a refers to a scalar function that encodes the similarity between the POI name vector and the POI address vector, and R refers to a set of real numbers. The first matrix representing the POI name may be generated by combining vectors representing the name segments (e.g., combining portions of the POI name vector corresponding to the name segments), wherein the t-th column of the first matrix (i.e., H_{:t}) corresponds to the t-th name segment. The second matrix representing the POI address may be generated by combining vectors representing the address segments (e.g., combining portions of the POI address vector corresponding to the address segments), wherein the j-th column of the second matrix (i.e., U_{:j}) corresponds to the j-th address segment. The interactive attention component 830 may determine the similarity matrix (also denoted by S) based on similarities between each name segment in the POI name vector and each address segment in the POI address vector.

After determining the similarity matrix, the interactive attention component 830 may determine the fifth attention weight and the sixth attention weight according to Equation (4) and Equation (5) illustrated below respectively:

aₜ=softmax(S_{t:}), (4)

where aₜ refers to a fifth attention weight of a t-th name segment with respect to the POI address, S_{t:} refers to a t-th column vector of the similarity matrix, and softmax refers to a function for normalization. The interactive attention component 830 may determine a fifth attention weight matrix (or vector) (also denoted by a) based on the fifth attention weights of the name segments with respect to the POI address.

b=softmax(max_{col}(S)), (5)

where b refers to a sixth attention weight matrix (or vector) including the sixth attention weights of the address segments with respect to the POI name, S refers to the similarity matrix, and max_{col} refers to a maximum function which is performed across columns of a matrix and is used to determine a maximum value of each column. As used herein, the maximum function is performed on columns of the similarity matrix, maximum values in the columns are determined, and the maximum values are processed by softmax to determine b.

The interactive attention component 830 may determine the third vector 804 representing the POI string 802 based on the fifth attention weight of each name segment and the sixth attention weight of each address segment.

In some embodiments, the interactive attention component 830 may perform a concatenation and/or a fully-connected operation on the fifth attention weight matrix (or vector) and the sixth attention weight matrix (or vector) to determine a first fully-connected vector. The interactive attention component 830 may designate the first fully-connected vector as the third vector 804 representing the POI string 802.

Alternatively, the interactive attention component 830 may determine a modified POI address vector and a modified POI name vector. The modified POI address vector and the modified name vector may be determined according to Equation (6) and Equation (7) illustrated below respectively:

P=b×U, (6)

where P refers to the modified POI address vector, b refers to the sixth attention weight matrix (or vector), and U refers to the POI address vector.

N=a×H, (7)

where N refers to the modified POI name vector, a refers to the fifth attention weight matrix (or vector), and H refers to the POI name vector.
Further, the interactive attention component 803 may perform a concatenation and/or a fully-connected operation on the modified POI address vector and the modified POI name vector to determine a second fully-connected vector. The interactive attention component 830 may designate the second fully-connected vector as the third vector 804 representing the POI string 802.

It should be noted that the above description of the second module is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. In some embodiments, one or more components may be added or omitted in the second module. For example, the second module 620 may further include a fully-connected layer configured to perform a fully-connected operation on the third vector 804, thereby making the dimension of the third vector 804 same as that of the first vector 603. In some embodiments, the fifth attention weight and the sixth attention weight may be determined in a similar manner, for example, both of them may be determined according to the Equation (4) or Equation (5).

FIG. 9 is a flowchart illustrating an exemplary process for generating a text similarity determination model according to some embodiments of the present disclosure. In some embodiments, one or more operations of process 900 may be executed by the O2O service system 100. For example, the process 900 may be implemented as a set of instructions (e.g., an application) stored in a storage device (e.g., the storage device 160, the ROM 230, the RAM 240, the storage 390.) and invoked and/or executed by the processing engine 112B (e.g., the processor 220 of the computing device 200 and/or the modules illustrated in FIG. 4B). In some embodiments, the instructions may be transmitted in a form of electronic current or electrical signals. The operations of the illustrated process present below are intended to be illustrative. In some embodiments, the process 900 may be accomplished with one or more additional operations not described and/or without one or more of the operations herein discussed. Additionally, the order in which the operations of the process as illustrated in FIG. 9 and described below is not intended to be limiting.

In 910, the processing engine 112B (e.g., the obtaining module 404) (e.g., the interface circuits of the processor 220) may obtain a plurality of search records related to a plurality of historical user queries. The processing engine 112B may obtain the plurality of search records from a storage device (e.g., the storage device 160), such as the ones disclosed elsewhere in the present disclosure.

In some embodiments, each of the plurality of search records may include a historical user query, a historical recommended search strategy in response to the historical user query, and a user feedback regarding the historical recommended search strategy. As used herein, the user feedback may refer to a selection of the historical recommended search strategy by the user or not, which means a “positive user feedback” and a “negative user feedback” respectively.

Take a historical user query associated with an intended location as an example, when the user inputted the historical user query via the terminal device, the O2O service system 100 provided at least one historical recommend POI to the terminal device in response to the historical user query. The user may have selected one of the at least one historical recommended POI as a service location (e.g., a historical start location, a historical destination), and the remainder of the at least one historical recommended POI was not selected by the user. In this situation, a search record includes the historical user query, one of the at least one historical recommended POI, “the user selected the historical recommended POI or not.”

In 920, the processing engine 112B (e.g., the determination module 405) (e.g., the processing circuits of the processor 220) may determine a first set of search records with positive user feedbacks (also referred to as “positive samples”) from the plurality of search records.

In 930, the processing engine 112B (e.g., the determination module 405) (e.g., the processing circuits of the processor 220) may determine a second set of search records with negative user feedbacks (also referred to as “negative samples”) from the plurality of search records.

In 940, the processing engine 112B (e.g., the obtaining module 404) (e.g., the processing circuits of the processor 220) may obtain a preliminary model. As described in connection with FIG. 6, the preliminary model may include a preliminary first module, a preliminary second module, and a preliminary similarity determination layer, which may have a plurality of preliminary parameters. The plurality of preliminary parameters may include a segmentation parameter, an embedding parameter, the number of kernels, sizes of the kernels, etc. The plurality of preliminary parameters may be default settings of the O2O service system 100 or may be adjustable in different situations.

In 950, the processing engine 112B (e.g., the training module 406) (e.g., the processing circuits of the processor 220) may generate a text similarity determination model by training the preliminary model using the first set of search records with positive user feedbacks and the second set of search records with negative user feedbacks. In some embodiments, for each search record of the first set and the second set, the training module 406 may determine a sample similarity score between the historical user query and the corresponding historical recommended search strategy based on the preliminary model. The training module 406 may determine a loss function of the preliminary model based on the sample similarity scores corresponding to each search record and determine the text similarity determination model.

In some embodiments, the training module 406 may determine the text similarity determination model by updating the preliminary parameters iteratively to minimize the value of the loss function of the preliminary model. The iteration to minimize the value of the loss function may be terminated until a termination condition is satisfied. An exemplary termination condition is that the value of the loss function with the updated parameters obtained in an iteration is less than a threshold. The threshold may be default settings by the O2O service system 100 or may be adjustable in different situations. In response to the determination that the value of the loss function is less than the threshold, the processing engine 112B may designate the preliminary model as the trained text similarity determination model. On the other hand, in response to the determination that the value of the loss function is larger than or equal to the threshold, the processing engine 112B may execute the process 900 to update the preliminary model until the value of the loss function is less than the threshold. For example, the processing engine 112B may update the plurality of preliminary parameters. Further, if the processing engine 112B determines that under the updated parameters, the value of the loss function is less than the threshold, the processing engine 112B may designate the updated preliminary model as the trained text similarity determination model. On the other hand, if the processing engine 112B determines that under the updated parameters, the value of the loss function is larger than or equal to the threshold, the processing engine 112B may still execute the process 900 to further update the parameters. The iteration may continue until the processing engine 112B determines that under newly updated parameters the value of the loss function is less than the threshold, and the processing engine 112B may designate the updated preliminary model as the trained text similarity determination model. Other exemplary termination conditions may include that a certain iteration count of iterations are performed, that the loss function converges such that the differences of the values of the loss function obtained in consecutive iterations are within a threshold, etc.

It should be noted that the above description of the process 900 is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. In some embodiments, one or more operations may be omitted and/or one or more additional operations may be added. For example, operations 920 and 930 may be combined into a single operation. As another example, a test operation may be added after operation 950 to test the test similarity determination model.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure, and are within the spirit and scope of the exemplary embodiments of this disclosure.

Moreover, certain terminology has been used to describe embodiments of the present disclosure. For example, the terms “one embodiment,” “an embodiment,” and/or “some embodiments” mean that a particular feature, structure or characteristic described in connection with the embodiment is included in at least one embodiment of the present disclosure. Therefore, it is emphasized and should be appreciated that two or more references to “an embodiment,” “one embodiment,” or “an alternative embodiment” in various portions of this specification are not necessarily all referring to the same embodiment. Furthermore, the particular features, structures or characteristics may be combined as suitable in one or more embodiments of the present disclosure.

Further, it will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “block,” “module,” “engine,” “unit,” “component,” or “system.” Furthermore, aspects of the present disclosure may take the form of a computer program product embodied in one or more computer readable media having computer readable program code embodied thereon.

A computer readable signal medium may include a propagated data signal with computer readable program code embodied therein, for example, in baseband or as part of a carrier wave. Such a propagated signal may take any of a variety of forms, including electro-magnetic, optical, or the like, or any suitable combination thereof. A computer readable signal medium may be any computer readable medium that is not a computer readable storage medium and that may communicate, propagate, or transport a program for use by or in connection with an instruction execution system, apparatus, or device. Program code embodied on a computer readable signal medium may be transmitted using any appropriate medium, including wireless, wireline, optical fiber cable, RF, or the like, or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB. NET, Python or the like, conventional procedural programming languages, such as the “C” programming language, Visual Basic, Fortran 1703, Perl, COBOL 1702, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a software as a service (SaaS).

Furthermore, the recited order of processing elements or sequences, or the use of numbers, letters, or other designations, therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose, and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software-only solution—e.g., an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various embodiments. This method of disclosure, however, is not to be interpreted as reflecting an intention that the claimed subject matter requires more features than are expressly recited in each claim. Rather, claimed subject matter may lie in less than all features of a single foregoing disclosed embodiment.

1. A system for determining at least one recommended search strategy in response to a user query received from a terminal device, comprising:
a data exchange port adapted to communicate with the terminal device;
at least one non-transitory computer-readable storage medium having stored thereon a set of computer-executable instructions; and
at least one processor adapted to communicate with the data exchange port and the at least one non-transitory computer-readable storage medium, wherein when executing the set of instructions, the at least one processor is configured to direct the system to:
receive the user query from the terminal device via the data exchange port, the user query comprising at least one first segment;
in response to the user query, obtain a plurality of search strategies matching the user query, each of the plurality of search strategies comprising at least one second segment;
obtain a text similarity determination model, the text similarity determination model being adapted to incorporate an attention mechanism;
for each of the plurality of search strategies, determine a similarity score between a first vector representing the user query and a second vector representing the search strategy, wherein the similarity score is determined by inputting the user query and the search strategy into the text similarity determination model, wherein at least one of the first vector or the second vector is associated with an attention weight of each corresponding segment, the attention weight being determined based on the attention mechanism;
determine, among the plurality of search strategies, the at least one recommended search strategy based on the similarity scores; and
transmit the at least one recommended search strategy to the terminal device for display.

2. The system of claim 1, wherein the text similarity determination model comprises:
a first module configured to generate the first vector based on the user query;
a second module configured to generate the second vector based on the search strategy, and
a similarity determination layer configured to determine the similarity score between the first vector and the second vector.

3. The system of claim 2, wherein the first module comprises:
a contextual representation component configured to determine a first feature vector of the user query; and
an attention extraction component configured to generate the first vector based on the first feature vector of the user query, wherein the first vector is associated with a first attention weight of each first segment in the first vector.

4. The system of claim 3, wherein the contextual representation component comprises:
a segmentation layer configured to segment the user query into the at least one first segment;
an embedding layer configured to generate a word embedding of the user query; and
a convolution layer configured to extract the first feature vector of the user query from the word embedding of the user query.

5. The system of claim 3, wherein the attention extraction component of the first model comprises:
a normalization layer configured to normalize the first feature vector of the user query; and
a self-attention layer configured to determine the first attention weight of each first segment in the normalized first feature vector, and generate a modified first feature vector based on the normalized first feature vector and the first attention weight of each first segment.

6. The system of claim 5, wherein the attention extraction component of the first model further comprises:
a fully-connected layer configured to process the modified first feature vector to generate the first vector, the first vector having the same number of dimensions as the second vector.

7. The system of claim 2, wherein the user query is related to a location, and the plurality of search strategies include a plurality of point of interest (POI) strings, each of the POI string including the at least one second segment.

8. The system of claim 7, wherein each of the plurality of POI strings includes a POI name and a corresponding POI address, the at least one second segment of each of the plurality of POI strings includes at least one name segment of the corresponding POI name and at least one address segment of the corresponding POI address, and the second model comprises:
a POI name unit configured to determine a POI name vector representing the POI name;
a POI address unit configured to determine a POI address vector representing the POI address; and
an interactive attention component configured to generate a third vector representing the POI string based on the POI name vector and the POI address vector, the third vector being associated with a second attention weight of each name segment and each address segment in the third vector.

9. The system of claim 8, wherein the POI name unit comprises:
a first contextual representation component configured to determine a POI name feature vector of the POI name; and
a first attention extraction component configured to generate the POI name vector based on the POI name feature vector, the POI name vector being associated with a third attention weight of each name segment in the POI name vector.

10. The system of claim 9, wherein the POI address unit comprises:
a second contextual representation component configured to determine a POI address feature vector of the POI address; and
a second attention extraction component configured to generate the POI address vector based on the POI address feature vector, the POI address vector being associated with a fourth attention weight of each address segment of the POI address.

11. The system of claim 10, wherein to generate the third vector representing the POI string based on the POI name vector and the POI address vector, the interactive attention component is further configured to:
determine a similarity matrix between the POI name vector and the POI address vector;
determine, based on the similarity matrix, a fifth attention weight of each name segment with respect to the POI address and a sixth attention weight of each address segment with respect to the POI name; and
determine the third vector representing the POI string corresponding to the POI name vector and the POI address based on the fifth attention weight of each name segment and the sixth attention weight of each address segment.

12. The system of claim 1, wherein the text similarity determination model is trained according to a model training process, the model training process comprising:
obtaining a plurality of search records related to a plurality of historical user queries, each of the plurality of search records including a historical recommended search strategy in response to one of the plurality of historical user queries and a user feedback regarding the historical recommended search strategy;
determining, from the plurality of search records, a first set of search records with positive user feedbacks;
determining, from the plurality of search records, a second set of search records with negative user feedbacks;
obtaining a preliminary model; and
generating the text similarity determination model by training the preliminary model using the first set of search records and the second set of search records.

13. The system of claim 12, wherein the generating the text similarity determination model further includes:
for each search record of the first set and the second set, determining a sample similarity score between the historical user query corresponding to the search record and the corresponding historical recommended search strategy based on the preliminary model;
determining a loss function of the preliminary model based on the sample similarity scores corresponding to each search record; and
determining the text similarity determination model by minimizing the loss function of the preliminary model.

14. A method for determining at least one recommended search strategy in response to a user query received from a terminal device, comprising:
receiving the user query from the terminal device via the data exchange port, the user query comprising at least one first segment;
in response to the user query, obtaining a plurality of search strategies matching the user query, each of the plurality of search strategies comprising at least one second segment;
obtaining a text similarity determination model, the text similarity determination model being adapted to incorporate an attention mechanism;
for each of the plurality of search strategies, determining a similarity score between a first vector representing the user query and a second vector representing the search strategy, wherein the similarity score is determined by inputting the user query and the search strategy into the text similarity determination model, wherein at least one of the first vector or the second vector is associated with an attention weight of each corresponding segment in the corresponding vector, the attention weight being determined based on the attention mechanism;
determining, among the plurality of search strategies, the at least one recommended search strategy based on the similarity scores; and
transmitting the at least one recommended search strategy to the terminal device for display.

15. The method of claim 14, wherein the text similarity determination model comprises:
a first module configured to generate the first vector based on the user query;
a second module configured to generate the second vector based on the search strategy, and
a similarity determination layer configured to determine the similarity score between the first vector and the second vector.

16-19. (canceled)

20. The method of claim 15, wherein the user query is related to a location, and the plurality of search strategies include a plurality of point of interest (POI) strings, each of the POI string including the at least one second segment.

21. The method of claim 20, wherein each of the plurality of POI strings includes a POI name and a corresponding POI address, the at least one second segment of each of the plurality of POI strings includes at least one name segment of the corresponding POI name and at least one address segment of the corresponding POI address, and the second model comprises:
a POI name unit configured to determine a POI name vector representing the POI name;
a POI address unit configured to determine a POI address vector representing the POI address; and
an interactive attention component configured to generate a third vector representing the POI string based on the POI name vector and the POI address vector, the third vector being associated with a second attention weight of each name segment and each address segment in the third vector.

22-24. (canceled)

25. The method of claim 14, wherein the text similarity determination model is trained according to a model training process, the model training process comprising:
obtaining a plurality of search records related to a plurality of historical user queries, each of the plurality of search records including a historical recommended search strategy in response to one of the plurality of historical user queries and a user feedback regarding the historical recommended search strategy;
determining, from the plurality of search records, a first set of search records with positive user feedbacks;
determining, from the plurality of search records, a second set of search records with negative user feedbacks;
obtaining a preliminary model; and
generating the text similarity determination model by training the preliminary model using the first set of search records and the second set of search records.

26. The method of claim 25, wherein the generating the text similarity determination model further includes:
for each search record of the first set and the second set, determining a sample similarity score between the historical user query corresponding to the search record and the corresponding historical recommended search strategy based on the preliminary model;
determining a loss function of the preliminary model based on the sample similarity scores corresponding to each search record; and
determining the text similarity determination model by minimizing the loss function of the preliminary model.

27. (canceled)

28. A non-transitory computer-readable storage medium embodying a computer program product, the computer program product comprising instructions configured to cause a computing device to:
receive the user query from the terminal device via the data exchange port, the user query comprising at least one first segment;
in response to the user query, obtain a plurality of search strategies matching the user query, each of the plurality of search strategies comprising at least one second segment;
obtain a text similarity determination model, the text similarity determination model being adapted to incorporate an attention mechanism;
for each of the plurality of search strategies, determine a similarity score between a first vector representing the user query and a second vector representing the search strategy, wherein the similarity score is determined by inputting the user query and the search strategy into the text similarity determination model, wherein at least one of the first vector or the second vector is associated with an attention weight of each corresponding segment in the corresponding vector, the attention weight being determined based on the attention mechanism;
determine, among the plurality of search strategies, the at least one recommended search strategy based on the similarity scores; and
transmit the at least one recommended search strategy to the terminal device for display.
